(19) United States
(12) Patent Application Publication
(10) Pub. No.: US 2023/0289353 A1
(43) Pub. Date: Sep. 14, 2023

(54) SYSTEMS AND METHODS FOR PROVIDING ORGANIZATIONAL NETWORK ANALYSIS USING SIGNALS AND EVENTS FROM SOFTWARE SERVICES IN USE BY THE ORGANIZATION

(71) Applicant: Peoplelogic, Inc., Durham, NC (US)

(72) Inventors: Matthew Paul Schmidt, Durham, NC (US); Hernâni Henrique Ramos Cerqueira, Arcos de Valdevez (PT)

(21) Appl. No.: 18/179,829

(22) Filed: Mar. 7, 2023

Related U.S. Application Data
(60) Provisional application No. 63/318,342, filed on Mar. 9, 2022.

(51) Int. Cl. G06F 16/2455; G06F 16/28; G06F 16/25

(52) U.S. Cl. CPC G06F 16/24568; G06F 16/288; G06F 16/252; G06F 16/285

(57) ABSTRACT

Systems and methods for generating data representing the health of an organization, such as a business or other collection of individuals working toward a common goal, are disclosed. Data streams are received from various software services or tools that are used by the organization and those data streams are analyzed to provide early warning and predictive intelligence about the health of the organization. For example, the systems and methods described herein are configured to predict when an employee is at risk for turnover or to identify when a process is broken.

### CROSS-REFERENCE TO RELATED APPLICATION

This application claims the benefit of priority of U.S. provisional patent application no. 63/318,342, titled “SYSTEMS AND METHODS FOR PROVIDING ORGANIZATIONAL NETWORK ANALYSIS USING SIGNALS AND EVENTS FROM SOFTWARE SERVICES IN USE BY THE ORGANIZATION”, filed on Mar. 9, 2022, which is incorporated by reference herein in its entirety.

### TECHNICAL FIELD

The present invention relates to systems and methods for providing organization network analysis using signals and events from software services in use by the organization. More specifically, the present invention relates to gathering real-time event data streams from software services in use by the organization and analyzing those data streams to provide actionable intelligence.

### BACKGROUND

Traditionally, data relating to performance of an organization, as a whole, has been held captive in a web of software solutions, employee surveys, and countless spreadsheets and other documents. This makes gathering insight about the organization a time-consuming process that is usually out-of-date by the time the insights are gathered, and out-of-mind for decision makers, who are busy focusing on the day-to-day operation of the organization.

Accordingly, a need exists for a system that can generate insights about the performance of an organization organically and in nearly real-time.

### SUMMARY

The presently disclosed subject matter is directed toward systems and methods for generating data representing the health of an organization, such as a business or other collection of individuals working toward a common goal. The systems and methods described herein receive or intercept data streams from various internal or external software services and tools that are used by the organization and analyze those data streams to provide early warning and predictive intelligence about the health of the organization. For example, the systems and methods described herein are configured to predict when an employee is at risk for turnover or to identify when an internal process is broken.

The systems and methods described herein provide a practical application in that they unlock valuable insights into an organization's health and generates actionable tips to increase team engagement while quantifying and driving operational efficiency based on information and data flow within the organization that would otherwise be unavailable to decision makers. The systems and methods described herein assist leaders of the organization in understanding the interconnectivity of their people and processes by leveraging output from the tools the organization uses daily or frequently.

The systems and methods described herein display actionable intelligence to decision-makers to help them make informed decisions on how to best lead their teams, be on the lookout for team members that are becoming disengaged, assess process workflow, and surface recommendations based on patterns and behaviors that could negatively impact the organization's overall health. The systems and methods described herein obviate the need for extra surveys, assessments, or data input, and instead layer seamlessly into an organization's existing technology (e.g., email, customer relationship management (“CRM”), internal communications, and the like) to generate an early warning and response system for organizational health.

By using a foundation of application integrations, the systems and methods described herein determine and break down the silos of where work is occurring within the organization. The data and signals flowing back and forth between applications is analyzed for interconnectedness, by asserting a viewpoint of the clustering of activity and where unique events are occurring across all employees, tools and locations that together contribute to the signals that describe overall health of organizations and the unique value each person provides to the organization.

The degree of data (e.g., streams, events) that is required for these models to perform is disproportionately smaller, allowing the methods and systems described herein to obtain value from artificial-intelligence model insights in a shorter amount of time, and with a less diverse integration basis. This allows for faster deployment to more users. There is a learning aspect for the artificial-intelligence model that delivers accretive customer value. In the deployed models, their leanings are fed back into generic models, such that future deployments benefit from the real-time learning. This cyclical learning relationship provides a novel architecture and implementation. Over time, the models improve because the initial set of inputs use a set of common parameters that allows for project and organizational health measurement or OHF. As organizations overlay broader set of integrations, this increased the number of signals, data events, and streams are used to refine the OHF number. This is then applied to the canonical model to allow base models to provide more accurate and sustainable initial OHF numbers.

### BRIEF DESCRIPTION OF THE DRAWINGS

FIG. 1 depicts an exemplary process flow for a method of providing organization network analysis according to an embodiment of the subject matter described herein.

FIG. 2 depicts a system 200 illustrating a further embodiment of organizational health analysis system according to an embodiment of the subject matter described herein.

FIG. 3 illustrates an example block diagram of one embodiment of the back-end server 204 of FIG. 2 according to an embodiment of the subject matter described herein.

FIG. 4 depicts a block diagram illustrating one embodiment of a computing device 400 according to an embodiment of the subject matter described herein.

FIG. 5 depicts an exemplary software-as-a-service (SaaS) model according to an embodiment of the subject matter described herein.

FIG. 6 depicts an exemplary graph for visualizing relationships according to an embodiment of the subject matter described herein.

FIG. 7 depicts an example block diagram of one embodiment of a functional architecture of an organizational health analysis system according to an embodiment of the subject matter described herein.

FIG. 8 (collectively including FIGS. 8A, 8B, 8C, and 8D) depicts a universal markup language (UML) diagram of a signal structure according to an embodiment of the subject matter described herein.

FIG. 9 depicts an example block diagram of one embodiment of a functional architecture of an organizational health analysis system according to an embodiment of the subject matter described herein.

### DETAILED DESCRIPTION

The following description and figures are illustrative and are not to be construed as limiting. Numerous specific details are described to provide a thorough understanding of the disclosure. In certain instances, however, well-known or conventional details are not described in order to avoid obscuring the description. References to “one embodiment” or “an embodiment” in the present disclosure may be (but are not necessarily) references to the same embodiment, and such references mean at least one of the embodiments.

Reference in this specification to “one embodiment” or “an embodiment” means that a particular feature, structure, or characteristic described in connection with the embodiment is included in at least one embodiment of the disclosure. Multiple appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

The systems and methods described herein perform Organizational Network Analysis (ONA) on the received data. ONA is a quantitative method for modeling and analyzing how communications, information, decisions and resources flow through an organization. It is used in a variety of fields, including business management and the social and behavioral sciences. ONA may be used to gain a better understanding of the relationships that affect the effectiveness of individuals and groups. The actual real-world interactions between individuals in the organization are collected via signals to model the ONA. These interactions may be modeled in a graph weighted by number and/or quality of the interactions. The interactions may further be coded by sentiment. Each node in the graph may represent an individual, a team, or an external entity, depending on the context.

The systems and methods described herein use ONA to determine an Organizational Health Factor (OHF) and a Stay Factor (SF). The OHF provides a quantitative value that scores the overall organizational health of the organization. The OHF is an algorithmically produced score that combines externally acquired data sources with the internal signals and event data and the generated ONA to provide a measure of people and process health for the organization. The OHF provides a high-level indication of areas within an organization where there is a potential for attrition, burnout, or ineffective processes.

The OHF is unique in that it uses previously unused individual data from the software services or tools that are already in use by the organization and process that data in near real-time to produce a score that becomes more accurate as more data is collected. The OHF uses an artificial-intelligence model that learns and expands as more data is collected, thereby improving the model over time.

Various external factors may be used in the OHF, such as, for example, headcount grown rate over a previous period of time, average tenure, a GlassdoorTM score, sentiment of reviews across various online review sites, tool complexity, salary vs. benchmark, and/or revenue growth rate.

Various internal factors may be used in the OHF, such as, for example, signals from real-time events (e.g., stress, count, impact, sentiment, and the like), ONA (the strength of the connections to the team and the manager), achievement of goals (both near term and historical), forward career motion internally (e.g., promotions), anomaly detection that identifies changes in behavior, process identification and understanding (e.g., to identify unnecessary work being performed repeatedly).

A low-confidence OHF may be generated using entirely external data. The addition of internal information relies on machine-learning to analyze the large amount of data being aggregated from the internal software services and tools. The internal information is provided to an artificial-intelligence model that uses machine-learning or other deep-learning techniques to model the internal information.

The SF provides a quantitative value that indicates a particular employee's likelihood of remaining with the organization, as opposed to leaving to find another organization.

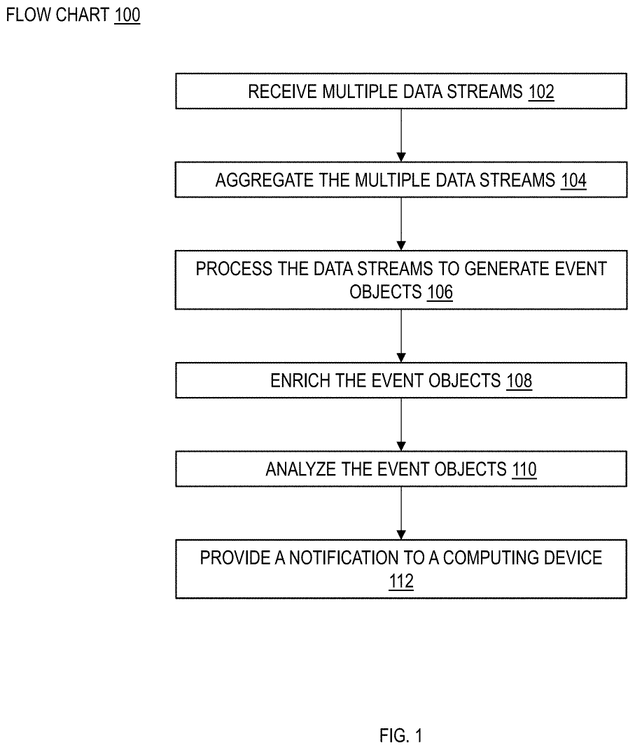

FIG. 1 depicts an exemplary process flow for a method of providing organization network analysis. Referring to FIG. 1, the method includes, at step 102, receiving or intercepting multiple data streams from one or more servers providing software services during the use of the software services by users from the organization. The multiple data streams are received or intercepted independent of the users interacting with the software services. At least one of the multiple data streams may be received via an application programming interface (API) from one of the one or more servers providing software services. At least one of the multiple data streams may be received or intercepted as a raw data object from one of the one or more servers providing software services.

Incoming data is received or intercepted as signals, and those signals are converted into event objects. The event objects represent discrete actions or points in time that include properties that are relevant to a particular user's interactions with the one or more software services. The event objects evolve over time as the user's interactions with the software services change.

The incoming data streams may be received or intercepted in real-time, or they may be polled periodically as part of a periodic event gathering process. The incoming data streams are collected for each connection, and the collected data is converted into signals. Many software services provide an event stream via APIs, which is preferred because such event streams rely on the software services own history data to generate events. Many other software services do not provide APIs, so the incoming data is collected as raw object data, which are then converted into events using data analysis such as, for example, heuristics. As one example, a CRM tool might return data about each sales opportunity, and that data might contain a few specific dates, like creation date, or close date, which can be used to generate a creation event and a closing event. Some software services may be configured to notify the server of every event.

In various embodiments, the one or more servers providing software services may include a communication tool server, a customer relationship management (CRM) tool server, a support tool server, a developer tool server, a collaboration and work management tool server, a human resources management and recruitment tool server, and/or a custom event uploader.

The method further includes, at step 104, aggregating the multiple data streams. As explained above, there may be many incoming data streams from various sources and in various data formats. The incoming data streams are aggregated. They may be aggregated by arrival time, by type of stream, or the like.

The method further includes, at step 106, processing the data streams to generate one or more events objects related to the data streams. As explained above, the incoming data streams or signals are converted into event objects, which allows for the streams to be assigned various data or tags that is later used in analyzing the event objects.

The method further includes, at step 108, enriching the event objects to standardize the event objects. Enriching the event objects may include adding data to the objects, removing data from the objects, reformatting the objects, adding cross-references to other objects based on relationship data, or the like.

The method further includes, at step 110, analyzing the event objects to identify patterns in the event objects. In one embodiment, the analysis is performed using machine-learning and/or an artificial-intelligence model.

Machine learning (ML) is the use of computer algorithms that can improve automatically through experience and by the use of data. Machine learning algorithms build a model based on sample data, also known as training data, to make predictions or decisions without being explicitly programmed to do so. Machine learning algorithms are used where it is unfeasible to develop conventional algorithms to perform the needed tasks.

In certain embodiments, instead of, or in addition to, performing the functions described herein manually, the system may perform some or all of the functions using machine learning or artificial intelligence. Thus, in certain embodiments, machine learning- enabled software relies on unsupervised and/or supervised learning processes to perform the functions described herein in place of a human user.

Machine learning may include identifying one or more data sources and extracting data from the identified data sources. Instead of or in addition to transforming the data into a rigid, structured format, in which certain metadata or other information associated with the data and/or the data sources may be lost, incorrect transformations may be made, or the like, machine learning-based software may load the data in an unstructured format and automatically determine relationships between the data. Machine learning-based software may identify relationships between data in an unstructured format, assemble the data into a structured format, evaluate the correctness of the identified relationships and assembled data, and/or provide machine learning functions to a user based on the extracted and loaded data, and/or evaluate the predictive performance of the machine learning functions (e.g., “learn” from the data).

In certain embodiments, machine learning-based software assembles data into an organized format using one or more unsupervised learning techniques. Unsupervised learning techniques can identify relationships between data elements in an unstructured format.

In certain embodiments, machine learning-based software can use the organized data derived from the unsupervised learning techniques in supervised learning methods to respond to analysis requests and to provide machine learning results, such as a classification, a confidence metric, an inferred function, a regression function, an answer, a prediction, a recognized pattern, a rule, a recommendation, or other results. Supervised machine learning, as used herein, comprises one or more modules, computer executable program code, logic hardware, and/or other entities configured to learn from or train on input data, and to apply the learning or training to provide results or analysis for subsequent data.

Machine learning-based software may include a model generator, a training data module, a model processor, a model memory, and a communication device. Machine learning-based software may be configured to create prediction models based on the training data. In some embodiments, machine learning-based software may generate decision trees. For example, machine learning-based software may generate nodes, splits, and branches in a decision tree. Machine learning-based software may also calculate coefficients and hyper parameters of a decision tree based on the training data set. In other embodiments, machine learning-based software may use Bayesian algorithms or clustering algorithms to generate predicting models. In yet other embodiments, machine learning-based software may use association rule mining, artificial neural networks, and/or deep learning algorithms to develop models. In some embodiments, to improve the efficiency of the model generation, machine learning-based software may utilize hardware optimized for machine learning functions, such as an FPGA.

The machine-learning and/or artificial-intelligence model may perform, for example, anomaly detection, regression, clustering, or association.

Anomaly detection may be used based on the count of events per employee and/or teams, broken down, for example, by day, week, month, or year. Anomaly detection may be used based on count of words and/or messages sent over various messaging systems (e.g., Slack™). Anomaly detection may be based on count and/or duration of tickets. Anomaly detection may be based on sales. Anomaly detection may be based on time spent attending and/or participating in meetings. In various embodiments, the anomaly detection may be performed using Density-Based Spatial Clustering of Applications with Noise (DBSCAN), an Isolation Forest algorithm, or a statistical-based algorithm.

Anomaly detection may use classification-based methods, proximity-based methods, clustering-based methods, statistical-based methods, graphical-based methods, contextual anomaly detection methods, and/or collective anomaly detection methods.

When using classification-based methods, a classification model is built for normal and anomalous (i.e., rare) events based on labeled training data, and the classification model is used to classify each new unseen event. Classification models must be able to handle skewed (imbalanced) class distributions. Supervised classification techniques require knowledge of both normal and anomaly class. They build a classifier to distinguish between normal and known anomalies. The supervised classification techniques may include rule-based techniques (e.g., adapting existing rule-based techniques, association rules, feature/rule weighting, P-N rule learning, or CREDOS), model-based techniques (e.g., NN-based, SVM-based, or Bayesian network-based), and ensemble-based techniques (e.g., SMOTEBoost, or RareBoost). Semi-supervised classification techniques require knowledge of normal class only. They use a modified classification model to learn the normal behavior and detect any deviations from normal behavior as anomalous. The semi-supervised classification techniques may include NN-based, SVM-based, Markov models, and rule-based techniques.

When using proximity-based methods, normal points are assumed to have close neighbors while anomalies are assumed to be located far from other points. A two-step approach is used. First, a neighborhood is computed for each data record. Second, the neighborhood is analyzed to determine whether the data record is an anomaly or not. A K-Nearest Neighbor computation determines the distance between every pair of data points. The distance measured can be simple Euclidean distance for real values. This may be performed using Local Outlier factor (LOF), Connectivity Outlier Factor (COF), or Multi-Granularity Deviation Factor (LOCI). Distance-based methods assume that anomalies are data points most distant from other points. Density-based methods assume that anomalies are data points in low-density regions.

When using clustering-based methods, normal data records belong to large and dense clusters, while anomalies do not belong to any of the clusters or form very small clusters. DBSCAN is an example algorithm used where anomaly points are assigned to the cluster. Some of the approaches used are K-means and hierarchical, which are used to find points away from any mean and it tries to find clusters with few data points. For non-clustering-based methods, most algorithms are based on the creation of normal profiles. So instead of building a model relying on normal instances, the algorithm isolates anomalous points in the dataset (e.g., Isolation forest).

When using statistical-based methods, anomalies can be identified by the creation of a statistical distribution model. A probability distribution is assumed that the error follows a normal distribution. A threshold for classifying an outlier may be specified (e.g., three standard deviations from the mean). Any data point that is, for example, more than three standard deviations may be identified as an outlier. The statistical-based methods may include parametric techniques and non-parametric techniques. Parametric techniques assume that the normal (and possibly anomalous) data is generated from an underlying parametric distribution. They learn the parameters from the normal sample and determine the likelihood of a test instance to be generated from this distribution to detect anomalies. Non-parametric techniques do not assume any knowledge of parameters, and they use non-parametric techniques to learn a distribution (e.g., parzen window estimation).

When using graphical-based methods, a human decides if data is an outlier or not. Approaches include box plots, scatterplots, scatterplot matrix, and two-dimensional PCA.

Contextual anomaly detection methods are first used to identify a context around a data instance (using a set of contextual attributes), and then they are used to determine if the data instance is anomalous with respect to the context (using a set of behavioral attributes). All normal instances within a context will be similar (in terms of behavioral attributes), while the anomalies will be different. Techniques used try to reduce the anomaly to point anomaly detection. Data segmentation is made using contextual attributes that define a neighborhood for each instance (e.g., spatial, context, graph contexts, sequential contexts, profile contexts). It applies a traditional point outlier within each context using behavioral attributes, and then utilizes structure in data by building models from the data using contextual attributes such as time series models such as ARIMA.

Collective anomaly detection methods detect collective anomalies and try to exploit the relationship among data instances. Graph anomaly detection detects anomalous sub-graphs in graph data (e.g., edges, weights). Sequential anomaly detection in which detects anomalous sequences (e.g., position, time). Spatial anomaly detection detects anomalous sub-regions within a spatial data set (e.g., longitude, latitude).

Regression may be used to forecast the count of events, with anomaly detection being used to determine if one or more future events may be outliers. Regression may be used to forecast interactions. Regression may be used to forecast the stay factor. Regression may be used to forecast OHF.

Clustering may be used to profile employees and/or teams. Clustering may be used for anomaly detection. In various embodiments, clustering may be performed to determine the profile of an employee regarding the counts of each aggregator, meetings, interactions, job role, team, and the like.

Association may be used to determine common actions performed by the events. For example, associations may be created when there is a commit or a push, when an email is sent, when there is a contact update, or the like. In various embodiments, association may be performed to determine the precedent and consequent event. Association may be performed using an apriori algorithm.

The method further includes, at step 112, providing a notification to a computing device based on the identified patterns in the event objects. In one embodiment, the notification is provided to a front end of a computing device. The font end of the computing device may include a stand-alone application, a web browser-based application, and/or a third-party application.

Objects represent anything that would be referred to in an event, such as a support ticket, a project, a customer, or the like. Objects are the result of assembling contextual information provided by events but also during the enrichment process. Objects do not have a hard schema, and they can contain any number of properties, as well as the same signals that are collected in events.

Each signal contains a set of core properties to help identify it in the system. Table 1, below, provides a non-exhaustive list of signal properties that may be used.

TABLE 1

| PROPERTY | DESCRIPTION |
|---|---|
| SIGNAL DATE | SIGNAL DATE indicates the date and time |
| | when the event occurred. |
| TITLE | TITLE indicates the title of the event. |
| TYPE | TYPE indicates the type of event. The possible |
| | values are open ended. |
| CONTEXTUAL TYPE | CONTEXTUAL TYPE allows integrations to |
| | provide a type that better represents the |
| | nomenclature used by the various software |
| | services and can be used for manual querying |
| | and analysis. |
| PARTICIPANTS | PARTICIPANTS identifies one or more actors |
| | of an event, which may include each person that |
| | had a role in the event or was affected by the |
| | event. |
| TEXT | TEXT provides notes or other information about |
| | the event. |
| SENTIMENT | SENTIMENT may be categorized as MIXED, |
| | POSITIVE, NEUTRAL, NEGATIVE. |
| SENTIMENT SCORE | SENTIMENT SCORE provides a quantitative |
| | value based on the SENTIMENT. |
| DURATION MINUTES | DURATION MINUTES indicates the length of |
| | time of the event. |
| DURATION SCORE | DURATION SCORE provides a quantitative |
| | value of a rating of the duration of the event. |
| STRESS LEVEL | STRESS LEVEL may be categorized as VERY |
| | LOW, LOW, AVERAGE, HIGH, or VERY |
| | HIGH. |
| STRESS LEVEL SCORE | STRESS LEVEL SOCRE provides a |
| | quantitative value of a rating of a user's |
| | perceived stress level. |
| COMPLEXITY | COMPLEXITY may be categorized as VERY |
| | LOW, LOW, AVERAGE, HIGH, or VERY |
| | HIGH. |
| COMPLEXITY SCORE | COMPLEXITY SCORE provides a quantitative |
| | value of a rating of the complexity. |
| CUSTOMER IMPACT | CUSTOMER IMPACT may be categorized as |
| | VERY LOW, LOW, AVERAGE, HIGH, or |
| | VERY HIGH |
| CUSTOMER IMPACT SCORE | CUSTOMER IMPACT SCORE provides a |
| | quantitative value of a rating of CUSTOMER |
| | IMPACT. |
| ORGANIZATION IMPACT | ORGANIZATION IMPACT may be |
| | categorized as VERY LOW, LOW, |
| | AVERAGE, HIGH, or very high |
| ORGANIZATION IMPACT | ORGANIZATION IMPACT SCORE provides |
| SCORE | a quantitative value of a rating of |
| | ORGANIZATION IMPACT. |

### Example Use Case: Managing Employee Engagement and Performance

Employee engagement is a human resources (HR) concept that describes the level of enthusiasm and dedication a worker feels toward their job. Engaged employees care about their work and about the performance of the company and feel that their efforts make a difference.

Measuring employee engagement has traditionally been performed using surveys. However, one drawback of such surveys is that they may only present aggregated sentiments of employees and do not provide actions for improving engagement. ONA, however, may provide more individualized context behind employee sentiments and actions for correcting or sustaining various employee engagement measures.

For example, a company's engagement survey may indicate that 30% of employees felt inadequately trained. As a result, a manager may invest more in training programs. However, ONA may indicate that employees dislike current training programs because the training programs do not broadly share institutional knowledge. As a result, instead of investing in more training programs, a manager may improve institutional knowledge sharing via a wiki or inter-departmental meetings.

Insights can become invaluable in the day-to-day decisions and communication of organizational leaders and managers. For example, employees with prominent levels of network communication often have more context and understanding around their tasks and projects, leading to higher engagement and performance levels. Employees who have stronger connections at work may also be likely to be more engaged.

Disengagement can be seen in a graph when a node is moving away from the overall network. The direction(s) the node moves may be important signals of disengagement and increasing detractors. For example, variances and trends in network scores and/or signals may be indicators of increasing or decreasing engagement levels. For example, decreases in reciprocity, out-reach, and influence scores are often an indication of decreasing engagement. Same with stress and sentiment levels.

In addition to measuring, monitoring, and managing employee engagement, combining the information from the graph can create a new metric for employee performance measurement. Considering the impact levels that employees and team nodes have on the network may help identify the best communicators, bridges, and informal influencers amongst the team. This insight can be used to leverage individual and team strengths to plan an effective and successful organizational health initiative.

It is appreciated that the holistic view of performance provided by the tools disclosed herein can help across leadership responsibilities. For example, hiring managers can look for the qualities needed for new hires to increase the success of the team and help identify the individuals best suited for promotions and leadership or management tracks. Better understanding the strengths of teams and employees within the network can also help with workload management and delegation.

In terms of team and department management, groups or clusters of nodes may represent those who only speak to a certain part of the team. This insight can be important in finding where communication bottlenecks might be occurring and where unblocking needs to occur.

In addition to the employee engagement and performance management aspects discussed above, the subject matter described herein can also be applied to change management. For example, managers and leaders can look for assistance from informal influencers, hubs, or bridge employees in the graph when making process changes, communicating a shift in business needs, or onboarding new employees. These members often have a higher influence and authority on the team than the managers themselves and can help shape positive, trusting team cultures through understanding conflicts, predicting roadblocks, and facilitating new processes or information. Those with high authority scores, sentiment levels, influence scores, manageable stress levels, reciprocity scores, and impact levels are often better suited for managing change amongst the team.

When changes like onboarding new hires or introducing new roles post promotions occur on a team, it's important to measure the reactions of your team. Movements in the graph, especially movement between the outer rim and the middle of the network, can help measure the success of integrating new processes and people.

### Example Use Case: Predicting Employee Attrition

Attrition is when an employee leaves a company either voluntarily or involuntarily. The rate of attrition is the number of employees who have left the company as a percentage of the average number of employees. Predicting and managing employee attrition may be valuable to employers and managers. For example, by predicting whether an employee is likely to leave a company, action may be taken to prevent the employee from leaving.

It is appreciated, however, that just as too much attrition may be a problem, too little attrition can also be a problem. For example, if a low-performing employee or an employee who isn't the right fit for a company or position leaves, an opportunity is created to fill the role with a higher-performing employee or an employee who is a better fit for the position. Additionally, even in the case where a high-performing employee leaves on good terms, they may become an ambassador for the company and be part of desirable attrition.

In one embodiment, a model may calculate the attrition risk for an employee, also known as the stay factor (SF). The SF provides a quantitative value that indicates a particular employee's likelihood of remaining with the organization, as opposed to leaving to find another organization.

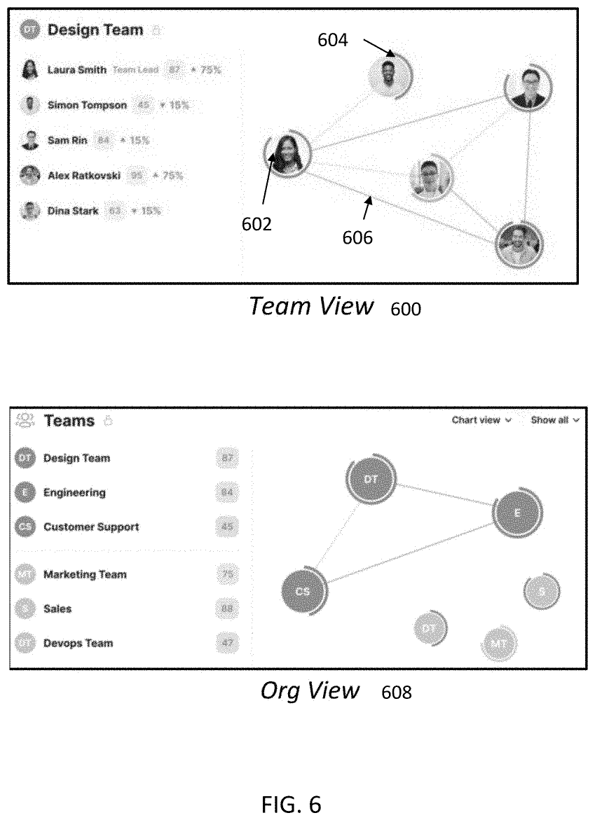

Combining the factors included in the calculation of the graph disclosed herein (e.g., FIG. 6 discussed below) helps leaders predict when disengagement and burnout is affecting employees to the point of increased attrition risk. Key indicators of increased attrition risk may include a node moving away from their network, decreased sentiment levels, decreased work-life balance, variances in KPI metrics, and team work-load imbalance. The earlier the signals leading to higher levels of attrition risk can be discovered, the higher chance an intervention has of improving the employee experience. Ultimately, saving the company resources and the high monetary costs associated with turnover.

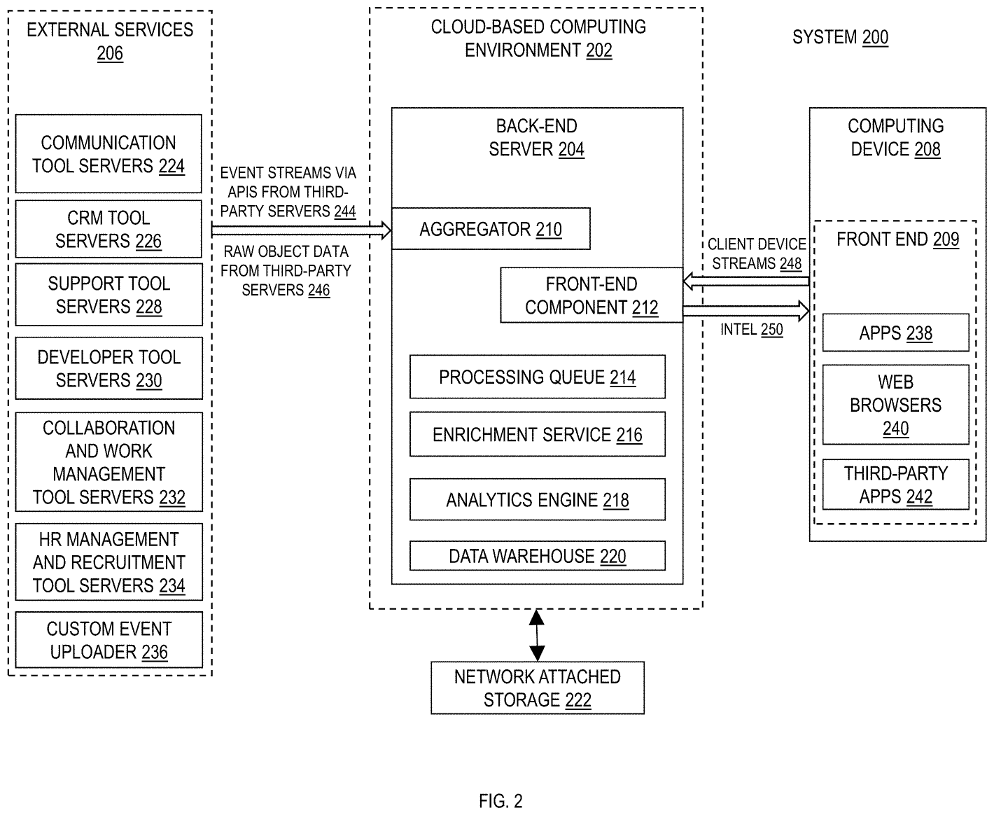

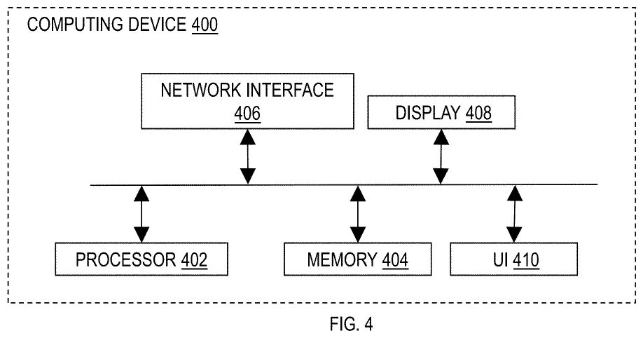

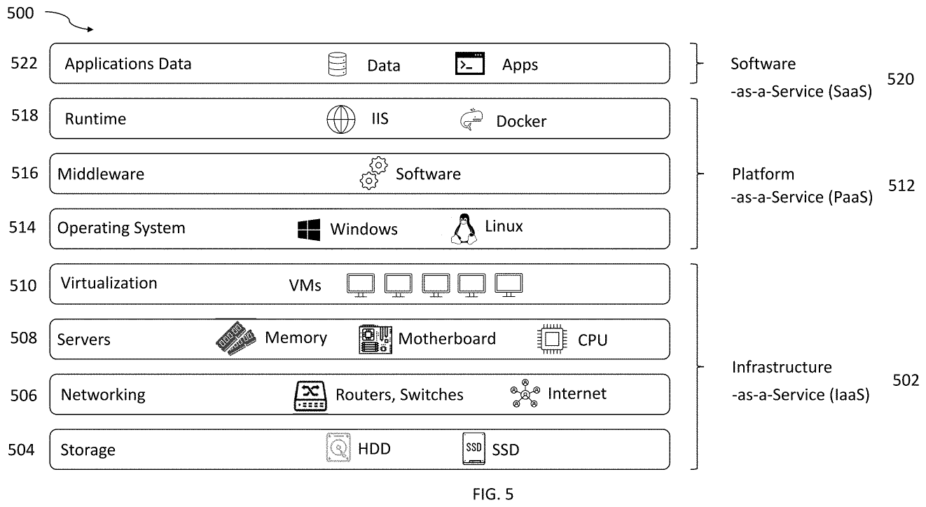

FIG. 2 depicts a system 200 illustrating a further embodiment of organizational health analysis system. Referring to FIG. 2, the system 200 includes a back-end server 204 implemented within a cloud-based computing environment 202. The back-end server 204 includes an aggregator 210, a processing queue 214, an enrichment service 216, an analytics engine 218, a data warehouse 220, and a front-end component 212. The back-end server 204 may include network attached storage 222. The front-end component 212 is configured to communicate with a front-end 209 of one or more computing devices 208. The computing devices 208 may be any computing device, including those described in the context of FIG. 4. The front-end 209 of the computing devices 208 may include a stand-alone application 238, a web browser-based dashboard 240, or an integration with a third-party application 242. The back-end server 204 is configured to use the front-end component 212 to receive client device streams 248 from the computing devices and to send intelligence 250 to the computing devices. The back-end server 204 may receive data via the aggregator 210. The aggregator collects incoming data as event streams via application programming interfaces (“APIs”) 244 and/or raw object data from third-party servers 246. The incoming data may come from one or more external services 206. The external services 206 may include, for example, communication tool servers 224, CRM tool servers 226, support tool servers 228, developer tool servers 230, collaboration and work management tool servers 232, human resources management and recruitment tool servers 234, and/or custom event uploaders 236.

The data warehouse 220 may be an open-source database such as the MongoDB® database, the PostgreSQL® database, or the like. An additional front-end component (not shown in FIG. 2) may be configured to provide an administrator access secure web portal. The administrator access secure web portal may be configured to provide status and control of the back-end server 204.

In some embodiments, the back-end server 204 may also use one or more transfer protocols such as a hypertext transfer protocol (HTTP) session, an HTTP secure (HTTPS) session, a secure sockets layer (SSL) protocol session, a transport layer security (TLS) protocol session, a datagram transport layer security (DTLS) protocol session, a file transfer protocol (FTP) session, a user datagram protocol (UDP), a transport control protocol (TCP), or a remote direct memory access (RDMA) transfer protocol.

The back-end server 204 may be implemented on one or more servers. The back-end server 204 may include a non-transitory computer readable medium including a plurality of machine-readable instructions which when executed by one or more processors of the one or more servers are adapted to cause the one or more servers to perform a method of organization network analysis. The method may include the method described in FIG. 1.

The system disclosed herein may be implemented as a client/server type architecture, but may also be implemented using other architectures, such as cloud computing, software as a service model (SaaS), a mainframe/terminal model, a stand-alone computer model, a plurality of non-transitory lines of code on a computer readable medium that can be loaded onto a computer system, a plurality of non-transitory lines of code downloadable to a computer, and the like.

The system may be implemented as one or more computing devices that connect to, communicate with and/or exchange data over a link that interact with each other. Each computing device may be a processing unit-based device with sufficient processing power, memory/storage and connectivity/communications capabilities to connect to and interact with the system. For example, each computing device may be an Apple iPhone or iPad product, a Blackberry or Nokia product, a mobile product that executes the Android operating system, a personal computer, a tablet computer, a laptop computer and the like and the system is not limited to operate with any particular computing device. The link may be any wired or wireless communications link that allows the one or more computing devices and the system to communicate with each other. In one example, the link may be a combination of wireless digital data networks that connect to the computing devices and the Internet. The system may be implemented as one or more server computers (all located at one geographic location or in disparate locations) that execute a plurality of lines of non-transitory computer code to implement the functions and operations of the system as described herein. Alternatively, the system may be implemented as a hardware unit in which the functions and operations of the back-end system are programmed into a hardware system. In one implementation, the one or more server computers may use Intel® processors, run the Linux operating system, and execute Java, Ruby, Regular Expression, Flex 4.0, SQL etc.

In some embodiments, each computing device may further comprise a display and a browser application so that the display can display information generated by the system. The browser application may be a plurality of non-transitory lines of computer code executed by a processing unit of the computing device. Each computing device may also have the usual components of a computing device such as one or more processing units, memory, permanent storage, wireless/wired communication circuitry, an operating system, etc.

The system may further comprise a server (that may be software based or hardware based) that allows each computing device to connect to and interact with the system such as sending information and receiving information from the computing devices that is executed by one or more processing units. The system may further comprise software- or hardware-based modules and database(s) for processing and storing content associated with the system, metadata generated by the system for each piece of content, user preferences, and the like.

In one embodiment, the system includes one or more processors, server, clients, data storage devices, and non-transitory computer readable instructions that, when executed by a processor, cause a device to perform one or more functions. It is appreciated that the functions described herein may be performed by a single device or may be distributed across multiple devices.

When a user interacts with the system, the user may use a frontend client application. The client application may include a graphical user interface that allows the user to select one or more digital files. The client application may communicate with a backend cloud component using an application programming interface (API) comprising a set of definitions and protocols for building and integrating application software. As used herein, an API is a connection between computers or between computer programs that is a type of software interface, offering a service to other pieces of software. A document or standard that describes how to build or use such a connection or interface is called an API specification. A computer system that meets this standard is said to implement or expose an API. The term API may refer either to the specification or to the implementation.

Software-as-a-service (SaaS) is a software licensing and delivery model in which software is licensed on a subscription basis and is centrally hosted. SaaS is typically accessed by users using a thin client, e.g., via a web browser. SaaS is considered part of the nomenclature of cloud computing.

Many SaaS solutions are based on a multitenant architecture. With this model, a single version of the application, with a single configuration (hardware, network, operating system), is used for all customers (“tenants”). To support scalability, the application is installed on multiple machines (called horizontal scaling). The term “software multitenancy” refers to a software architecture in which a single instance of software runs on a server and serves multiple tenants. Systems designed in such manner are often called shared (in contrast to dedicated or isolated). A tenant is a group of users who share a common access with specific privileges to the software instance. With a multitenant architecture, a software application is designed to provide every tenant a dedicated share of the instance—including its data, configuration, user management, tenant individual functionality and non-functional properties.

The backend cloud component described herein may also be referred to as a SaaS component. One or more tenants which may communicate with the SaaS component via a communications network, such as the Internet. The SaaS component may be logically divided into one or more layers, each layer providing separate functionality and being capable of communicating with one or more other layers.

Cloud storage may store or manage information using a public or private cloud. Cloud storage is a model of computer data storage in which the digital data is stored in logical pools. The physical storage spans multiple servers (sometimes in multiple locations), and the physical environment is typically owned and managed by a hosting company. Cloud storage providers are responsible for keeping the data available and accessible, and the physical environment protected and running. People and/or organizations buy or lease storage capacity from the providers to store user, organization, or application data. Cloud storage services may be accessed through a co-located cloud computing service, a web service API, or by applications that utilize the API.

A typical data pipeline according to one embodiment may begin by fetching data from one or more API sources. The fetched data may provided to a first stage in the data pipeline. For example, the first stage may be implemented as one or more Python scripts configured to query metadata, identify event types, identify objects, and identify participants. This data may then be sent to a second stage. The second stage of the data pipeline may begin by storing the raw data received from the first stage. This may include AWS Redshift cloud storage. In the second stage, the raw data may be transformed into ONA, OIR, and SF, which may be stored as clean data in a second AWS Redshift cloud data storage entity. This clean data may be accessed by a third stage which executes a software platform disclosed herein for visualizing and managing the data. For example, network graphs containing various layers of data insights may be presented to authenticated users via a web interface.

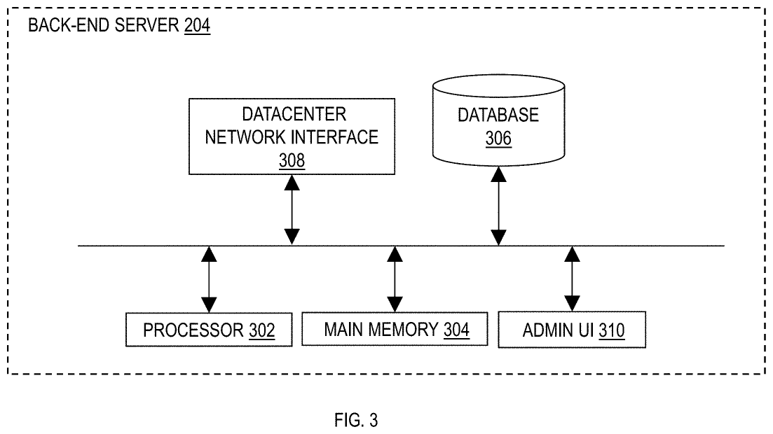

FIG. 3 illustrates an example block diagram of one embodiment of the back-end server 204 of FIG. 2. Referring to FIG. 3, the back-end server 204 may include at least one of processor 302, a main memory 304, a database 306, a datacenter network interface 308, and an administration user interface (UI) 310.

The processor 302 may be a multi-core server class processor suitable for hardware virtualization. The processor may support at least a 64-bit architecture and a single instruction multiple data (SIMD) instruction set. The main memory 304 may include a combination of volatile memory (e.g., random-access memory) and non-volatile memory (e.g., flash memory). The database 306 may include one or more hard drives.

The datacenter network interface 308 may provide one or more high-speed communication ports to the data center switches, routers, and/or network storage appliances. The datacenter network interface 308 may include high-speed optical Ethernet, InfiniBand (IB), Internet Small Computer System Interface (iSCSI), and/or Fibre Channel interfaces. The administration UI 310 may support local and/or remote configuration of the back-end server 204 by a datacenter administrator.

FIG. 4 depicts a block diagram illustrating one embodiment of a computing device 400. Referring to FIG. 4, the computing device may be a computing device 208 of FIG. 2. The computing device 400 may include at least one processor 402, a memory 404, a network interface 406, a display 408, and a UI 410. The memory 404 may be partially integrated with the processor 402. The UI 410 may include a keyboard and a mouse. The display 408 and the UI 410 may provide any of the GUIs in the embodiments of this disclosure. The computing device 400 may be a mobile device, such as a smart phone or a smart tablet that further includes a camera, WAN radios, and LAN radios. In some embodiments, the mobile device 600 may be a laptop, a tablet, or the like.

FIG. 5 is an illustration of an exemplary software-as-a-service (SaaS) model. Referring to FIG. 5, functionality 500 can be logically divided into layers. Layers may be ordered from least to greatest abstraction of underlying physical resources. Layers may also be divided into groups based on common features for simplicity when referring or billing functions associated with each group.

Infrastructure 502 includes storage function 504, networking function 506, server function 508, and virtualization function 510. Infrastructure functions 504-510 may be bundled together and provided to one or more tenants as a service, referred to as Infrastructure-as-a-Service (IaaS). IaaS is made up of a collection of physical and virtualized resources that provide consumers with the basic building blocks needed to run applications and workloads in the cloud.

Storage function 504 provides storage of data without requiring the user or tenant to be aware of how this data storage is managed. Three types of cloud storage that may be provided by storage function 504 are block storage, file storage, and object storage. Object storage is the most common mode of storage in the cloud because it is highly distributed (and thus resilient), data can be accessed easily over HTTP, and performance scales linearly as the storage grows.

Networking function 506 in the cloud is a form of software defined networking in which traditional networking hardware, such as routers and switches, are made available programmatically, typically through APIs.

Server function 508 refers to various physical hardware resources associated with executing computer-readable code that is not otherwise part of the virtualized network resources in networking function 506 or storage function 504. IaaS providers manage large data centers, typically around the world, that contain the servers powering the various layers of abstraction on top of them and that are made available to end users. In most IaaS models, end users do not interact directly with the physical infrastructure (e.g., memory, motherboard, CPU), but it is provided as a service to them.

Virtualization function 510 provides virtualization of underlying resources via one or more virtual machines (VMs). Virtualization relies on software to simulate hardware functionality and create a virtual computer system. A virtual computer system is known as a “virtual machine” (VM): a tightly isolated software container with an operating system and application inside. Each self-contained VM is completely independent. Putting multiple VMs on a single computer enables several operating systems and applications to run on just one physical server, or “host.” A thin layer of software called a “hypervisor” decouples the virtual machines from the host and dynamically allocates computing resources to each virtual machine as needed. Providers manage hypervisors and end users can then programmatically provision virtual “instances” with desired amounts of compute and memory (and sometimes storage). Most providers offer both CPUs and GPUs for different types of workloads.

Platform 512 includes operating system function 514, middleware function 516, and runtime function 518. Infrastructure functions 504-510 and platform functions 514-518 may be bundled together and provided to one or more tenants as a service, referred to as Platform-as-a-Service (PaaS). In the Platform-as-a-Service (PaaS) model, developers rent everything needed to build an application, relying on a cloud provider for development tools, infrastructure, and operating systems.

Operating system function 514 refers to a PaaS vendor providing and maintaining the operating system that developers use, and the application runs on. For example, Windows and Linux operating systems may be installed in virtual machines and Windows or Linux applications may be run within the operating system.

Middleware function 516 is software that sits in between user-facing applications and the machine's operating system. For example, middleware may allow software to access input from the keyboard and mouse. Middleware is necessary for running an application, but end users don't interact with it. Relatedly, middleware function 516 may also include tools that are necessary for software development, such as a source code editor, a debugger, and a compiler. These tools may be offered together as a framework.

Runtime function 518 is software code that implements portions of a programming language's execution model. A runtime system or runtime environment implements portions of an execution model. Most programming languages have some form of runtime system that provides an environment in which programs run. This environment may address issues including the management of application memory, how the program accesses variables, mechanisms for passing parameters between procedures, interfacing with the operating system, and otherwise. The compiler makes assumptions depending on the specific runtime system to generate correct code. Typically, the runtime system will have some responsibility for setting up and managing the stack and heap, and may include features such as garbage collection, threads or other dynamic features built into the language.

Software 520 includes applications and data function 522. Infrastructure functions 504-510, platform functions 514-518, and software function 522 may be bundled together and provided to one or more tenants as a service, referred to as Software-as-a-Service (SaaS). Applications and data function 522 is the application and associated data created and managed by the user. For example, an application programmed by the user for provided certain functionality disclosed herein may be exposed to the end user via a front end interface such as a web browser or dedicated front end client application. Neither the front end user nor the back end developer is required to manage or maintain services provided by platform 512 and infrastructure 502. This contrasts with on-site hosting of the same functionality.

FIG. 6 depicts an exemplary graph for visualizing relationships according to an embodiment of the subject matter described herein. Visualizing and analyzing formal and informal relationships in your organization can help you shape business strategy that maximizes organic exchange of information, thereby helping your business become more sustainable and effective. Organizational Network Analysis (ONA) is a structured method for visualizing how communications, information, and decisions flow through an organization.

Organizational networks consist of nodes and ties. People (nodes) serve as conduits for exchanging information. A connection delivers value when needed information is exchanged.

A central node is a person who has many connections to other people, shares lots of information, and influences others. Central nodes can be anywhere in the hierarchy of an organization, are often well liked, and are highly engaged in company news and developments.

A knowledge broker node is a person who bridges different groups. Without knowledge brokers, information sharing is often stunted.

A peripheral node is a person that is less connected or unconnected to most other nodes. A peripheral can be an advantage or a risk to organizations.

A relational tie refers to a formal and/or informal relationship between nodes. Optimizing relational ties between nodes, especially between central nodes and knowledge brokers, may ensure that useful information moves efficiently between and within groups of nodes.

After collecting data on an organization, a directed graph (network) may be generated. Nodes in the graph may be associated with one or more attributes, which allows nodes to be classified or grouped. After the network graph is generated, an analysis may be performed to determine influencers or other key actors in the organization (e.g., central nodes and knowledge brokers). Example factors affecting whether a node is a key actor may include: degree, closeness centrality, betweenness centrality, and classification of each node.

The degree of a node may be defined as the number of links from other nodes that point to the node. A directed network distinguishes between links that point to a node (in-degree) and links that point from a node to other nodes (out-degree).

Closeness centrality, or closeness index, may be a metric (e.g., between 0 and 1) that measures the average distance of a node to other nodes in the network. For example, this may include the number of steps, or hops, needed to reach a given node. This provides an average proximity of a node to the rest of the network. In one embodiment, a key actor may be a person with a closeness index above a certain threshold.

Betweenness centrality, or betweenness index, may be a metric (e.g., between 0 and 1) that quantifies the influence a node has on the information flow of the network. The betweenness index may be used, for example, to identify nodes that serve as a bridge between groups of nodes. The betweenness index may be determined based on the shortest path between all pairs of nodes. This provides a measure of the frequency at which a node is located between the shortest paths of other nodes.

Nodes may be classified into one or more types, and these types may exist on a continuum that is expressed as a metric between 0 and 1 indicating where a node exists on this continuum. For example, nodes may be classified into three types: regular, hub, and authority, where a hub node may have a classification score of 0, a regular node may have a classification score of 0.5, and an authority node may have a classification score of 1.

It may be appreciated that knowledge may be concentrated in a few nodes (authorities), that in turn are connected to a number of managers (hubs), that are then connected to a larger group of other nodes (regular). In the case of an organization network, authorities could be seen as leaders that communicate mainly with hubs, and hubs are people who act as bridges between authorities and regular employees.

Referring to FIG. 6, a user may use the graph to understand how people in an organization are connected to one another by easily navigating through the fully interactive graph, clicking on individual team members, and seeing their connections to each other. Behind each team, the user may view statistics and key information to help the user surface risks and act seamlessly. As the user moves throughout the graph, the user can see where team bonds are strong and discover team members on the fringes of the network.

The graph may also be used for understanding the people and process connections. For example, the user can use the graph to determine how teams approach their jobs on a daily or weekly basis, how well they are working well with others, and identity broken processes. As the user navigates through and drills down into more information, recommendations can surface potential root causes of inefficiencies and breakdowns. It is appreciated that these recommendations include more than binary process completion metrics. Instead, the algorithm can convey emotion and sentiment thereby allowing the user to assess employee engagement and mitigate team member attrition.

In FIG. 6, multiple views of the graph are shown. In Team view 600, an exemplary design team consisting of five nodes 602, representing members (Laura, Simon, Sam, Alex, Dina), is displayed in a connected graph.

Engagement levels may be represented by the color and rim 604 of each node 602. For example, Laura, Sam, and Alex may be shown with blue rims while Simon and Dina may be shown with orange or red rims. Additionally, Alex's rim surrounds 95 percent of his node representing the highest engagement level (95%) in the graph. Simon's rim, on the other hand, only surrounds 45 percent of his node representing the lowest engagement level (45%) in the graph. These engagement levels, as mentioned above, may also be correlated to the color of the rim (e.g., red for low engagement levels and blue for high engagement levels) for easier understanding when viewing the graph.

The strength of each connecting line 606 may represent the weight or number of interactions between the two nodes it's connecting. For example, a greater number of interactions may occur between Laura, Alex, and Sam and, therefore, the line weight or thickness of connections 606 between these nodes may be larger or thicker than other connections that have fewer interactions. The strength of each connecting line 606 may also be associated with a range of colors similar to those discussed above with respect to the rim color of each node. Here, stronger connections may be colored blue while weaker connections may be colored red. Additionally, a weaker, red connection line between, for example, Simon and Laura, may be less saturated to further indicate the strength of the connection between these nodes.

Referring to Organization view 608, the location of each node 602 may also provide insights into the relationship between that node (e.g., employee/team/department) and the network it exists in. In one embodiment, the graph may be calculated from the event data (and metadata) created by the tools and platforms used to accomplish work. Knowledge and communication flows from employee to employee and team to team in these tools. The graph can help teams identify internal collaboration patterns, organizational silos, and bottlenecks.

Using the statistical, graphical models and unique data structure disclosed herein, signals are created around what impacts a team's ability to communicate tasks, converse in groups, and share knowledge together. Signals that may impact the graph include, but are not limited to: Sentiment Levels, Complexity Levels, Stress Levels, Object & Entity Detection, Employee, Team, Organization, and Customer Impact Levels.

Beyond the insights a user may gather visually, the data used can also be calculated to discover deeper insights about the networks, including, but not limited to: Influence Scores, Degree Centralities, % of network interactions, Out-reach scores, In-reach scores, Reciprocity Scores, Hub Scores, Authority Scores, Closeness Scores.

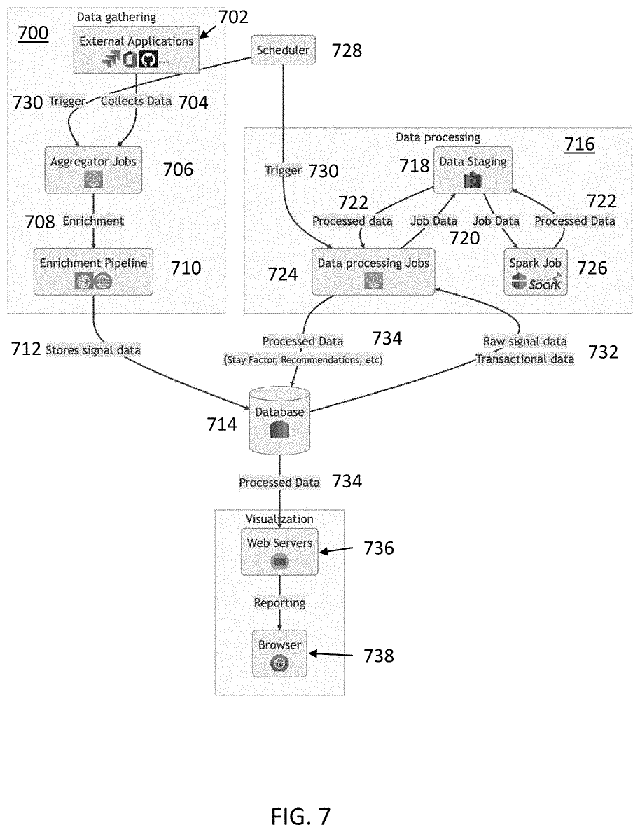

FIG. 7 depicts an example block diagram of one embodiment of a functional architecture of an organizational health analysis system according to an embodiment of the subject matter described herein.

Referring to FIG. 7, a first group of components or services 700 may be associated with data gathering. External applications 702, such as Microsoft Office 365 or GitHub, may provide data 704 to one or more aggregator jobs 706 of the data gathering module 700. These aggregator jobs 706 may combine and enrich the data received from the external applications 702. For example, enriching the event objects may include standardizing the event objects, adding data to the objects, removing data from the objects, reformatting the objects, adding cross-references to other objects based on relationship data, or the like. After enrichment, the enriched event objects 708 may be provided to an enrichment pipeline 710 which stores signal data 712 in an external database 714.

A second group of components or services 716 may be associated with data processing. For example, a data staging module 718 may exchange job data 720 and processed data 722 with one or more data processing jobs 724 and a Spark job 726.

Both the aggregator jobs 706 of the data gathering module 700 and the data processing jobs 724 of the data processing module 716 may be associated with a shared scheduler module 728. The scheduler 728 may provide trigger(s) 730 to the aggregator jobs 706 and the data processing jobs 724 for initiating various data collection and/or data processing tasks.

In addition to exchanging data with the data staging module 718, the data processing jobs 724 may receive raw signal and transactions data 732 from the same database 714 shared with the data gathering module 700. The output of the data processing jobs 724 may include processed data 734, such as Stay Factor(s), Recommendations, etc. This processed data 734 may also be stored in database 714.

The processed data 734 stored in the database may then be provided to other services. These services may be associated with, for example, visualization and reporting of the processed data. For example, one or more web servers 736 may receive the processed data 734 which is displayed via a web browser 738 configured to visualize the processed data 734 as, for example, a connected graph as described above.

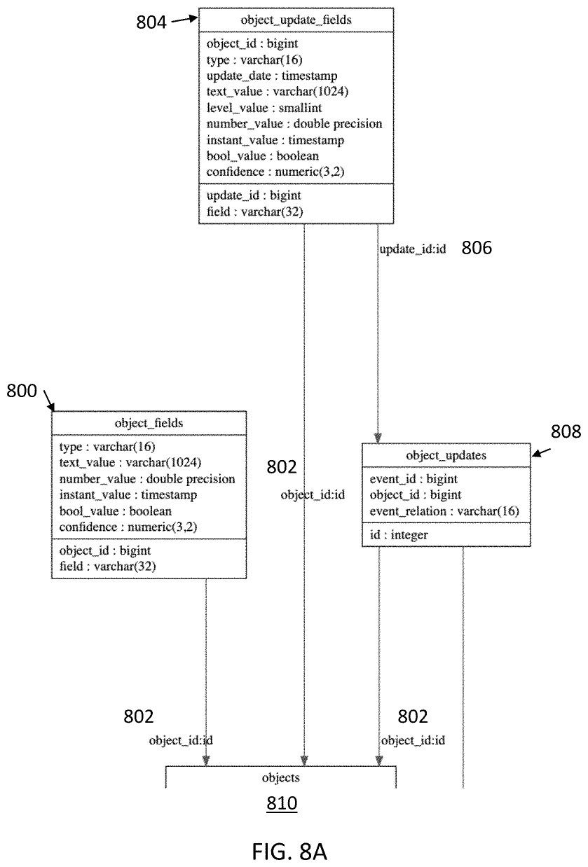

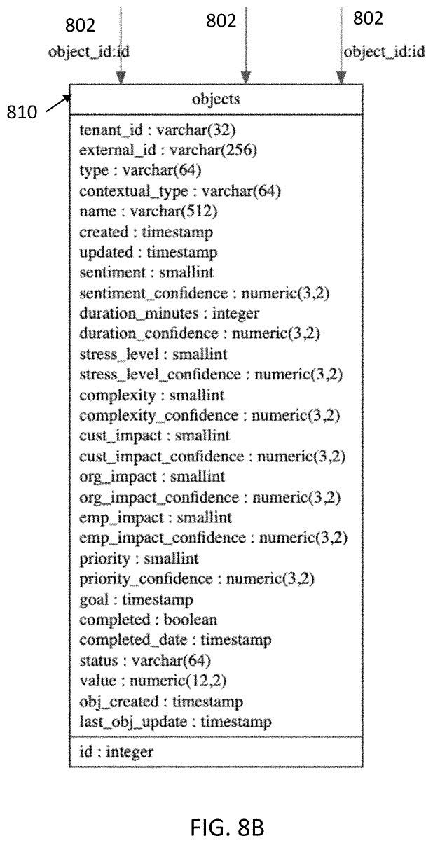

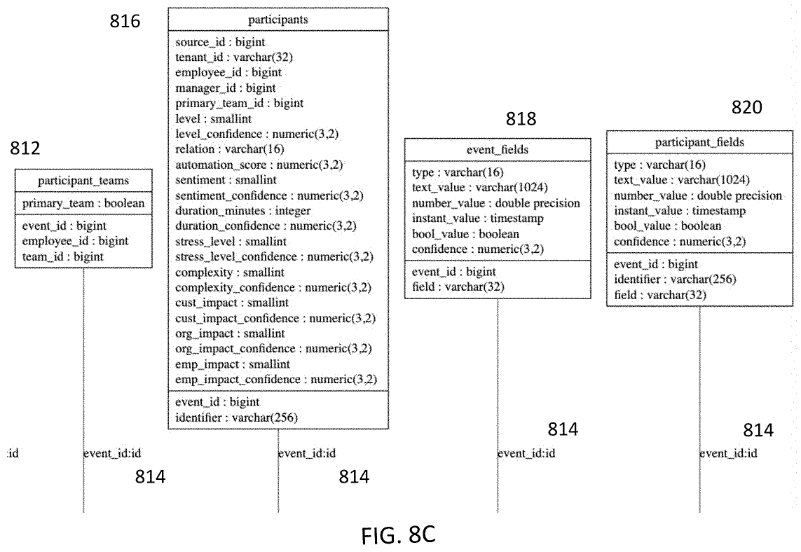

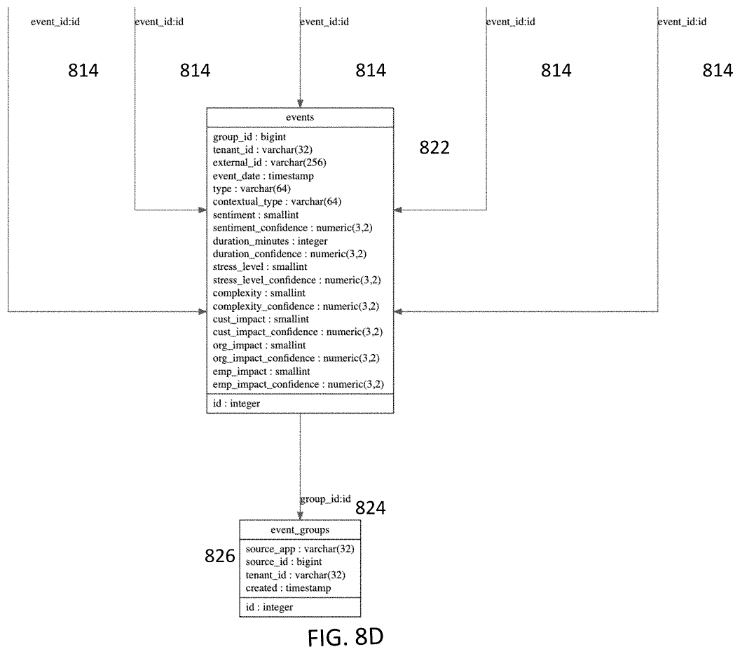

FIG. 8 (collectively including FIGS. 8A, 8B, 8C, and 8D) depicts a universal markup language (UML) diagram of a signal structure according to an embodiment of the subject matter described herein.

Referring to FIG. 8A, Object_fields 800 may include: type, text_value, number_value, instant_value, bool_value, and confidence. An object_id and field may also be associated with object_fields 800. The output of object_fields 800 includes object_id:id 802.

Object_update_fields 804 may include: object_id, type, update_date, text_value, level_value, number_value, instant_value, bool_value, and confidence. An update_id and field may also be associated with object_update_fields 800. The output of object_update_fields 800 also includes object_id:id 802.

Object_updates 808 may include: event_id, object_id, and event_relation. An id may also be associated with object_updates 808. The output of object_updates 808 includes object_id:id 802.

The object_id(s) 802 and the update_id 806 output by object_fields 800, object_update_fields 804, and object_updates 808 may be provided to objects 810.

Referring to FIG. 8B, objects 810 can include: tenant_id, external_id, type, contextual_type, name, updated, sentiment, sentiment_confidence, duration_minutes, stress_level, stress_level_confidence, complexity, complexity_confidence, customer_impact, customer_impact_confidence, organization_impact, organization_impact_confidence, employee_impact, employee_impact_confidence, priority, goal, completed, completed_date, status, value, obj_created, and last_object_update.

Referring to FIG. 8C, participant_teams 812 may include: primary_team, event_id, employee_id, and team_id. Participant_teams 812 may output event_id 814.

Participants 816 may include: source_id, tenant_id, employee_id, manager_id, primary_team_id, level, level_confidence, relation, sentiment, sentiment_confidence, duration_minutes, duration_confidence, stress_level, stress_level_confidence, complexity, complexity_confidence, customer_impact, customer_impact_confidence, organization_impact, organization_impact_confidence, and employee_impact, employee_impact_confidence. Participant_teams 812 may output event_id 814.

Event_fields 818 may include: type, text_value, number_value, instant_value, Boolean_value, and confidence. Event_fields 818 may be associated with an event_id and a field. Event_fields 818 may output event_id 814.

Participant_fields 820 may include: text_value, number_value, instant_value, Boolean_value, and confidence. Participant_fields 820 may be associated with an event_id, identifier, and a field. Participant_fields 820 may output event_id 814.

Referring to FIG. 8D, event_id(s) 814 may be provided by participant_teams 812, particpants_816, event_fields 818, and participant fields 820 to events 822. Events 822 may include: group_id, tenant_id, external_id, event_date, type, contextual_type, sentiment, sentiment_confidence, duration_minutes, duration_confidence, stress_level, stress_level_confidence, complexity, complexity_confidence, customer_impact, customer_impact_confidence, organization_impact, organization_impact_confidence, employee_impact, employee_impact_confidence.

Events 822 may provide group_id:id 824 to event_groups 826. Event_groups 826 may include: source_application, source_id, tenant_id.

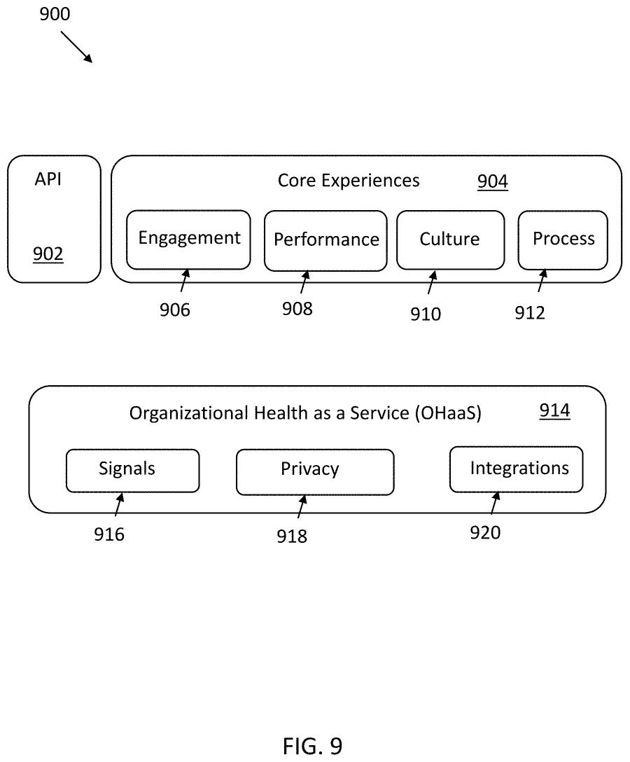

FIG. 9 depicts an example block diagram of one embodiment of a functional architecture of an organizational health analysis system according to an embodiment of the subject matter described herein. Referring to FIG. 9, system 900 may include an application programming interface (API) 902 and a core experiences module 904. Core experiences module 904 may include various applications of the organizational health as a service (OHaaS) platform disclosed herein relevant to a company, organization, manager, or employee. Core experiences module 904 may include, for example, engagement 906, performance 908, culture 910, and process 912.

Engagement 906 may include determining and visualizing a graph (of people), a StayFactor, BurnOut Factor, Sentiment, and other observations and recommendations. Performance 908 may include a graph (of entities), insights on entities and people tracking well and not tracking well, and other observations and recommendations. Culture 910 may include insights on culture tracking well and not tracking well, and other observations and recommendations. Process 912 may include a graph (of entities) and other observations and recommendations.

The OHaaS platform 914 may include signals 916, privacy 918, and integrations 920. As discussed above, real-world interactions between individuals in the organization are collected via signals 916 to model the ONA. These interactions may be modeled in a graph weighted by number and/or quality of the interactions. The interactions may further be coded by sentiment. Each node in the graph may represent an individual, a team, or an external entity, depending on the context. The OHF provides a quantitative value that scores the overall organizational health of the organization. The OHF is an algorithmically produced score that combines externally acquired data sources with the internal signals and event data and the generated ONA to provide a measure of people and process health for the organization. The OHF provides a high-level indication of areas within an organization where there is a potential for attrition, burnout, or ineffective processes. Also as discussed above, computing devices may include a stand-alone application, a web browser-based dashboard 240, or integration 920 with a third-party application.

As will be appreciated by one skilled in the art, aspects of the technology described herein may be embodied as a system, method or computer program product. Accordingly, aspects of the technology may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the technology may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the technology described herein may be written in any combination of one or more programming languages, including object oriented and/or procedural programming languages. Programming languages may include, but are not limited to: Ruby®, JavaScript®, Java®, Python®, PHP, C, C++, C#, Objective-C®, Go®, Scala®, Swift®, Kotlin®, OCaml®, or the like. The program code may execute entirely on the user's computer, partly on the user's computer, as a stand-alone software package, partly on the user's computer, and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the technology described herein refer to flowchart illustrations and/or block diagrams of methods, apparatus (systems) and computer program products according to various embodiments. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the technology described herein. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting. As used herein, the singular forms “a,” “an” and “the” are intended to include the plural forms as well, unless the context clearly indicates otherwise. Thus, for example, reference to “a user” can include a plurality of such users, and so forth. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description provided herein has been presented for purposes of illustration and description, but is not intended to be exhaustive or limited to the specific form disclosed. Many modifications and variations will be apparent to those of ordinary skill in the art without departing from the scope and spirit of the disclosure. The embodiment was chosen and described in order to best explain the principles described herein and the practical application of those principles, and to enable others of ordinary skill in the art to understand the technology for various embodiments with various modifications as are suited to the particular use contemplated.

The descriptions of the various embodiments of the technology disclosed herein have been presented for purposes of illustration, but these descriptions are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A server for providing organizational network analysis, the server comprising:
a memory;
a database; and
a processor that generates intelligence based on user operations, the processor being configured for:
receiving, from one or more servers that provide software services, multiple data streams during the use of the software services by users from the organization,
wherein the multiple data streams are received independent of the users interacting with the software services;
aggregating the multiple data streams;
processing the data streams to generate one or more events objects related to the data streams;
enriching the event objects to standardize the event objects;
analyzing the event objects to identify patterns in the event objects; and
providing a notification to a computing device based on the identified patterns in the event objects.

2. The server of claim 1, wherein at least one of the multiple data streams is received via an application programming interface (API) from one of the one or more servers that provide software services.

3. The server of claim 1, wherein at least one of the multiple data streams is received as a raw data object from one of the one or more servers that provide software services.

4. The server of claim 1, wherein the one or more servers that provide software services includes a communication tool server.

5. The server of claim 1, wherein the one or more servers that provide software services includes a customer relationship management (CRM) tool server.

6. The server of claim 1, wherein the one or more servers that provide software services includes a support tool server.

7. The server of claim 1, wherein the one or more servers that provide software services includes a developer tool server.

8. The server of claim 1, wherein the one or more servers that provide software services includes a collaboration and work management tool server.

9. The server of claim 1, wherein the one or more servers that provide software services includes a collaboration and work management tool server.

10. The server of claim 1, wherein the one or more servers that provide software services includes a human resources management and recruitment tool server.

11. The server of claim 1, wherein the one or more servers that provide software services includes a custom event uploader.

12. The server of claim 1, wherein analyzing the event objects to identify patterns in the event objects is performed using machine-learning.

13. The server of claim 12, wherein the machine-learning uses anomaly detection, regression, clustering, or association to identify patterns in the event objects.

14. The server of claim 1, wherein analyzing the event objects to identify patterns in the event objects is performed using artificial intelligence.

15. The server of claim 14, wherein the artificial intelligence uses anomaly detection, regression, clustering, or association to identify patterns in the event objects.

16. The server of claim 1, wherein the notification is provided to a front end of a computing device.

17. The server of claim 16, wherein the front end of the computing device includes a stand-alone application.

18. The server of claim 16, wherein the front end of the computing device includes a web browser-based application.

19. The server of claim 16, wherein the front end of the computing device includes a third-party application.

20. A computer-implemented method for performing organizational network analysis, the method comprising:
receiving, from one or more servers that provide software services, multiple data streams during the use of the software services by users from the organization,
wherein the multiple data streams are received independent of the users interacting with the software services;
aggregating the multiple data streams;
processing the data streams to generate one or more events objects related to the data streams;
enriching the event objects to standardize the event objects;
analyzing the event objects to identify patterns in the event objects; and
providing a notification to a computing device based on the identified patterns in the event objects.

21. The method of claim 20, wherein at least one of the multiple data streams is received via an application programming interface (API) from one of the one or more servers that provide software services.

22. The method of claim 20, wherein at least one of the multiple data streams is received as a raw data object from one of the one or more servers that provide software services.

23. The method of claim 20, wherein the one or more servers that provide software services includes a communication tool server.

24. The method of claim 20, wherein the one or more servers that provide software services includes a customer relationship management (CRM) tool server.

25. The method of claim 20, wherein the one or more servers that provide software services includes a support tool server.

26. The method of claim 20, wherein the one or more servers that provide software services includes a developer tool server.

27. The method of claim 20, wherein the one or more servers that provide software services includes a collaboration and work management tool server.

28. The method of claim 20, wherein the one or more servers that provide software services includes a collaboration and work management tool server.

29. The method of claim 20, wherein the one or more servers that provide software services includes a human resources management and recruitment tool server.

30. The method of claim 20, wherein the one or more servers that provide software services includes a custom event uploader.

31. The method of claim 20, wherein analyzing the event objects to identify patterns in the event objects is performed using machine-learning.

32. The method of claim 31, wherein the machine-learning uses anomaly detection, regression, clustering, or association to identify patterns in the event objects.

33. The method of claim 20, wherein analyzing the event objects to identify patterns in the event objects is performed using artificial intelligence.

34. The method of claim 33, wherein the artificial intelligence uses anomaly detection, regression, clustering, or association to identify patterns in the event objects.

35. The method of claim 20, wherein the notification is provided to a front end of a computing device.

36. The method of claim 35, wherein the front end of the computing device includes a stand-alone application.

37. The method of claim 35, wherein the front end of the computing device includes a web browser-based application.

38. The method of claim 35, wherein the front end of the computing device includes a third-party application.

39. A system for providing organizational network analysis, the system comprising:
a back-end server implemented within a cloud-based computing environment, the back-end server comprising:
an aggregator configured to receive, from one or more servers that provide software services, multiple data streams during the use of the software services by users from the organization,
wherein the multiple data streams are received independent of the users interacting with the software services;
a processing queue configured to process the data streams to generate one or more events objects related to the data streams;
an enrichment service configured to enrich the event objects to standardize the event objects;
an analytics engine configured to analyze the event objects to identify patterns in the event objects;
a data warehouse; and
a front-end component configured to communicate with a front-end of one or more computing devices to provide a notification to at least one of the computing devices based on the identified patterns in the event objects.

40. The system of claim 39, wherein the computing devices include a stand-alone application, a web browser-based dashboard 240, or an integration with a third-party application.

41. The system of claim 39, wherein the aggregator collects incoming data as event streams via application programming interfaces (“APIs”) from the one or more servers that provide software services.

42. The system of claim 39, wherein the aggregator collects incoming data as raw object data from the one or more servers that provide software services.

43. A system for providing organizational network analysis as a service (SaaS), the system comprising:
a computer communicatively coupled to a network, at least one SaaS provider, and at least one SaaS user, and wherein the computer is configured for:
receiving, from one or more servers that provide software services, multiple data streams during the use of the software services by users from the organization,
wherein the multiple data streams are received independent of the users interacting with the software services;
aggregating the multiple data streams;
processing the data streams to generate one or more events objects related to the data streams;
enriching the event objects to standardize the event objects;
analyzing the event objects to identify patterns in the event objects; and
providing a notification to a computing device based on the identified patterns in the event objects.

44. A computer-implemented method comprising instructions stored on a non-transitory computer-readable storage medium and executed on a computing device provided with a hardware processor and a memory for providing organizational network analysis via Software as a Service (SaaS), the method comprising:
receiving, from one or more servers that provide software services, multiple data streams during the use of the software services by users from the organization,
wherein the multiple data streams are received independent of the users interacting with the software services;
aggregating the multiple data streams;
processing the data streams to generate one or more events objects related to the data streams;
enriching the event objects to standardize the event objects;
analyzing the event objects to identify patterns in the event objects; and
providing a notification to a computing device based on the identified patterns in the event objects.
